(19) United States
(12) Patent Application Publication
(10) Pub. No.: US 2003/0015650 A1
(43) Pub. Date: Jan. 23, 2003

(54) Light collecting and focusing device

(76) Inventors: Joshua Clapper, Bryn Mawr, PA (US); Pete Smith, Folsum, CA (US)

Correspondence Address: BOEHRINGER INGELHEIM CORPORATION, 900 RIDGEBURY ROAD, P. O. BOX 368, RIDGEFIELD, CT, 06877, US

(21) Appl. No.: 10/026,012

(22) Filed: Dec. 21, 2001

Related U.S. Application Data
(60) Provisional application No. 60/307,565, filed on Jul. 23, 2001.
(60) Provisional application No. 60/307,566, filed on Jul. 23, 2001.

(51) Int. Cl. G06M 7/00

(52) U.S. Cl. 250/221

(57) ABSTRACT

A light collecting and focusing device for an ultrasonic digitizer has a conical tip and an infrared transparent polycarbonate light pipe. Infrared signals received by the conical tip are optically coupled to the photodiode through the light pipe. This device allows the use of a single photo diode mounted on the digitizer for receiving infrared signals from emitters that are not in the direct line of sight with the photodiode. Furthermore, optical coupling between the source of the infrared signals and the photodiode is maintained regardless of the orientation of the digitizer about its access.

### CROSS REFERENCE TO RELATED APPLICATIONS

This application claims the benefit of U.S. Provisional Patent Applications Nos. 60/307,565, filed on Jul. 23, 2001; and 60/307,566, filed on Jul. 23, 2001.

### FIELD OF THE INVENTION

The present invention generally relates to the field of optics, and more specifically to a device for collecting, redirecting, and focusing optical energy.

### BACKGROUND

Ultrasonic pen digitizer systems continue to grow in both popularity and importance. Typically, ultrasonic pen or stylus digitizer systems utilize an ultrasonic transducer and optical transmitters, such as an infrared light emitting diodes (LEDs), attached to a stylus. Such a system is described in U.S. Pat. No. 4,814,552, which is hereby incorporated by reference in its entirety. The optical transmitters, which are attached to the stylus, transmit optical signals, which are received almost instantaneously by an optical receiver (such as a photodiode). The ultrasonic transducer mounted to the stylus transmits acoustic pulses, which are received, with a delay as compared to receipt of the optical signal, by two (or more) receiver transducers positioned at fixed locations with respect to one another and having a specified separation therebetween. The position of the transducer and stylus is determined by triangulation from the measured time of the received signals from each of the receivers.

The optical receiver is mounted to a receiving portion of the system (not the stylus) such that it is in the line of sight of at least one of the LEDs mounted on the stylus. As a user “writes” with the stylus, it is not uncommon for the stylus to rotate. To ensure that the optical receiver is always in the line of sight of the optical transmitters, typical digitizing systems mount three LEDs to the stylus equidistantly positioned on a perimeter of the stylus tip. This configuration of the optical transmitters ensures that the optical receiver and at least one of the LEDs are in a line of sight with each other as the stylus tip is rotated.

Because of the plurality of LEDs required to maintain line of sight coupling, such a system dissipates a relatively large amount of power, requires electronic circuitry for each LED, and results in a relatively short battery life. A digitizer system, which reduces power consumption and reduces circuit complexity is desired.

### SUMMARY OF THE INVENTION

A device includes an optically conductive tip for redirecting an optical signal. The optically conductive tip is in direct line of sight of either the optical transmitter(s) or the optical receiver(s). The device also includes an optical conductor, which is optically coupled to the tip. The optical conductor is in direct line of sight of the other of the optical transmitter(s) or optical receiver(s).

Another aspect of the invention is an apparatus comprising a housing having a longitudinal axis. A first optical device is positioned within the housing. An optically conductive tip is mounted to the housing. An axis of the tip is coaxial with the axis of said housing. The tip is in direct line of sight of a second optical device. An optical conductor optically couples the first optical device to the tip. The first and second optical devices are optically coupled to each other by way of the tip and the optical conductor, regardless of an orientation of the housing about its longitudinal axis.

Another aspect of the invention is a system for determining the position of a stylus. The system comprises a fixed transceiving portion for transceiving ultrasonic and optical signals. The fixed transceiving portion comprises at least one ultrasonic transducer, and at least one optical receiver or at least one optical transmitter. The stylus comprises an ultrasonic transducer and one of the group consisting of a single optical transmitter and a single optical receiver. A position of the stylus is determined in accordance with the optical signals and propagation times of the ultrasonic signals.

### BRIEF DESCRIPTION OF THE DRAWINGS

The above and other advantages and features of the present invention will be better understood from the following detailed description of the preferred embodiments of the invention, which are provided in connection with the accompanying drawings. The various features of the drawings may not be to scale. Included in the drawing are the following figures:

FIG. 1 is a perspective view of a digitizer system in accordance with a first embodiment of the present invention;

FIG. 2 is an illustration of a portion of the stylus of FIG. 1;

FIG. 3 is an exploded view of the stylus of FIG. 1;

FIG. 4 is a perspective view of a digitizer system according an alternative embodiment of the present invention wherein the fixed transceiving portion comprises at least one optical transmitter and the stylus comprises an optical receiver; and

FIG. 5 is an illustration of a portion of the stylus of FIG. 4, wherein the stylus comprises an optical receiver.

### DETAILED DESCRIPTION

U.S. Provisional Patent Applications Nos. 60/307,565, filed on Jul. 23, 2001; and 60/307,566, filed on Jul. 23, 2001 are incorporated by reference in their entireties, as though set forth fully herein.

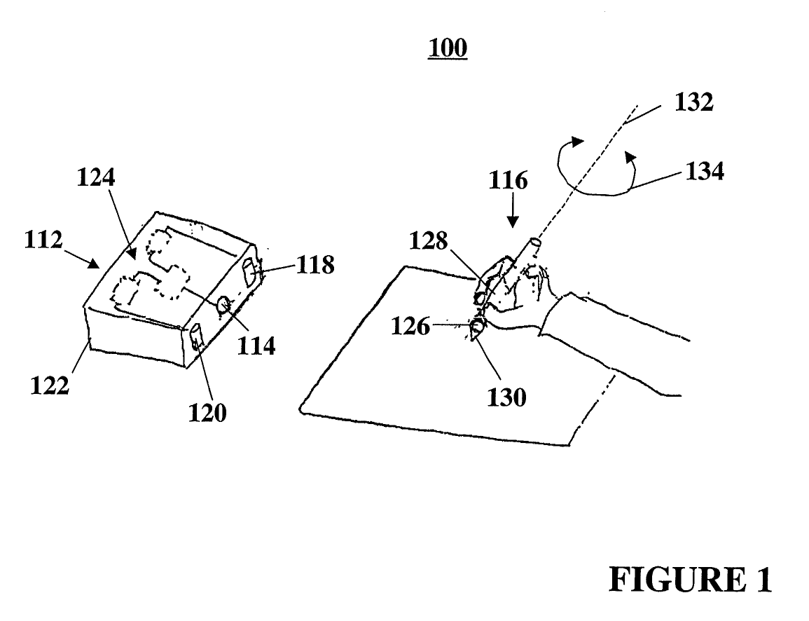

FIG. 1 is a perspective view of a digitizer system 100. Digitizer system 100 comprises a fixed transceiving portion 112 communicatively coupled with a portable transceiving portion (e.g., pen or stylus) 116. As used herein, a transceiver has the capability to transmit, receive, or both transmit and receive signals. Fixed transceiving portion 112 comprises a first ultrasonic transducer 118 fixed at a first position on a side surface of housing unit 122. Housing 122 preferably contains the electronic circuitry 124 for operation of the fixed transceiving system 112 and associated interconnections. Integration of the electronic circuitry 124 within the housing 122 may be accomplished in conventional fashion. A second ultrasound transducer 120 is fixed at a second position on the side surface of unit 112 such that the distance between the two transducers (118 and 120) is known. At least one optical detector 114, such as a photodetector or photodiode, is also positioned on the side surface of unit 112 for detecting optical signals. Electronic circuitry 124 is coupled to transducers 118, 120 and optical detector 114, and operates to process the electronic signals corresponding to the ultrasonic and optical signals utilized by the system 100 to perform timing measurements and triangulation calculations to determine the position of the stylus 116. In alternative embodiments, fixed transceiving portion 112 may be incorporated into a processor system, such as a personal computer and a video display device (e.g., a monitor).

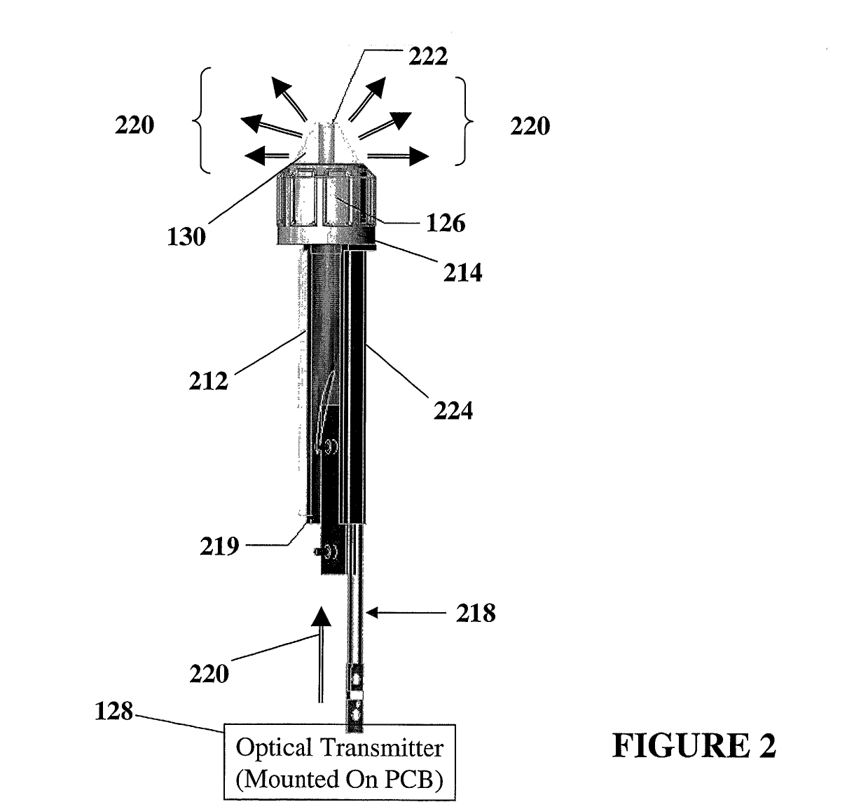

Portable transceiving portion 116 comprises an ultrasonic transducer 126 mounted onto a movable pen or stylus 116 and operative as a receiver and/or transmitter (i.e., transceiver) for receiving and/or transmitting ultrasonic signals from and/or to transceiving portion 112. An optical transmitter 128 is disposed on the stylus for transmitting optical signals to the fixed transceiving portion 112 to be received by optical receiver 114. Optical transmitter 128 is positioned within the stylus 116, and is hidden in FIG. 1. System 100 further comprises a light collecting and focusing device, tip 130, mounted to the stylus 116, and an optical conductor 222 (shown in FIG. 2) positioned within stylus 116, between the optical transmitter 128 and the tip 130.

In FIG. 1, the exemplary optical transmitter 128 comprises a single optical transmitter, such as a light-emitting diode (LED) or other such photoemitter mounted on the stylus 116 for transmitting optical signals through the optical conductor to the light collecting and focusing device 130 to the optical receiver 114 of fixed transceiver portion 112. Optical communication between the optical transmitter 128 and the at least one optical receiver 114 is maintained regardless of the orientation (see arrow 134) of the stylus 116 about its axis (see arrow 132).

As is known in the art of digitizers and ultrasonic positioning devices, the difference between the propagation time from one of the fixed ultrasonic transducers (such as ultrasonic transducer 118) to the stylus 116 and the propagation time from the other fixed ultrasonic transducer (such as ultrasonic transducer 120) to the same stylus is used to determine the position of the stylus. Also, as described in U.S. Pat. No. 4,814,552, optical signals are utilized to provide and receive timing and data information. Conventional digitizing systems, however, utilize a plurality of optical transmitters on the stylus to ensure that the optical signal is “seen” (i.e., in direct line of sight) by the optical receiver.

In exemplary stylus 116, optical coupling between the optical transmitter 128 and the optical receiver 114 is maintained, regardless of the orientation of the stylus 116 about its axis, using only a single optical transmitting device 128. Briefly, optical signals provided by optical transmitter 128 are optically coupled to tip 130 by an optical conductor 222 and an optically conductive channel 212 (shown in FIG. 2). The tip 130 redirects the optical signal such that the redirected optical signal is in direct line of sight with the optical receiver 114, regardless of the orientation of stylus 116 about its axis 132.

FIG. 2 shows a portion of the stylus 116. Stylus 116 comprises light collecting and focusing tip 130, optical conductor (light pipe) 222, ultrasonic transducer 126, protective grid 214, optical channel 212, and electrical conductors 218. Not shown in FIG. 2 is a flexible printed circuit board (PCB), which is electrically coupled to electrical conductors 218 and positioned within stylus 116, when stylus 116 is completely assembled, such that optical channel 212 is optically aligned with optical transmitter 128. Also, when stylus 116 is completely assembled, the housing 224 of stylus 116 completely encloses the PCB, however, only a portion of the housing 224 is shown for the sake of clarity.

In some embodiments, ultrasonic transducer 126 comprises Polyvinylidene Fluoride (PVDF), a polymer piezoelectric material, formed into a film, wherein the film is wrapped around a cylindrical member positioned within stylus 116. Such an ultrasonic transducer is described in U.S. Pat. No. 6,239,535, which is hereby incorporated by reference in its entirety. Various configurations of stylus 116 are envisioned. Descriptions of exemplary assembly configurations describing the coupling of the ultrasonic transducer to the cylindrical member, the coupling of the ultrasonic transducer to the electrical conductors, and the coupling of the electrical conductors to the flexible printed circuit board, are disclosed in provisional application nos. 60/307,565 and 60/307,566, incorporated by reference herein.

Arrows 220 indicate the direction and propagation paths of the optical signals provided by the optical transmitter 128. The optical signals (e.g., infrared signals, visible light) as provided by optical transmitter 128, are aligned with the optically conductive channel 212 at location 219. These optical signals propagate through the optically conductive channel 212 within the stylus 116, to light pipe 222 and tip 130. The optical signals are redirected by the tip 130 to propagate approximately omnidirectionally, so that the optical signals can be received by the optical receiver 114 (see FIG. 1). The axis of tip 130 is coaxial with the axis 132 of the stylus 116. Thus, the propagated optical signals are received by optical receiver 114, regardless of the orientation 134 of stylus 116 about its axis 132.

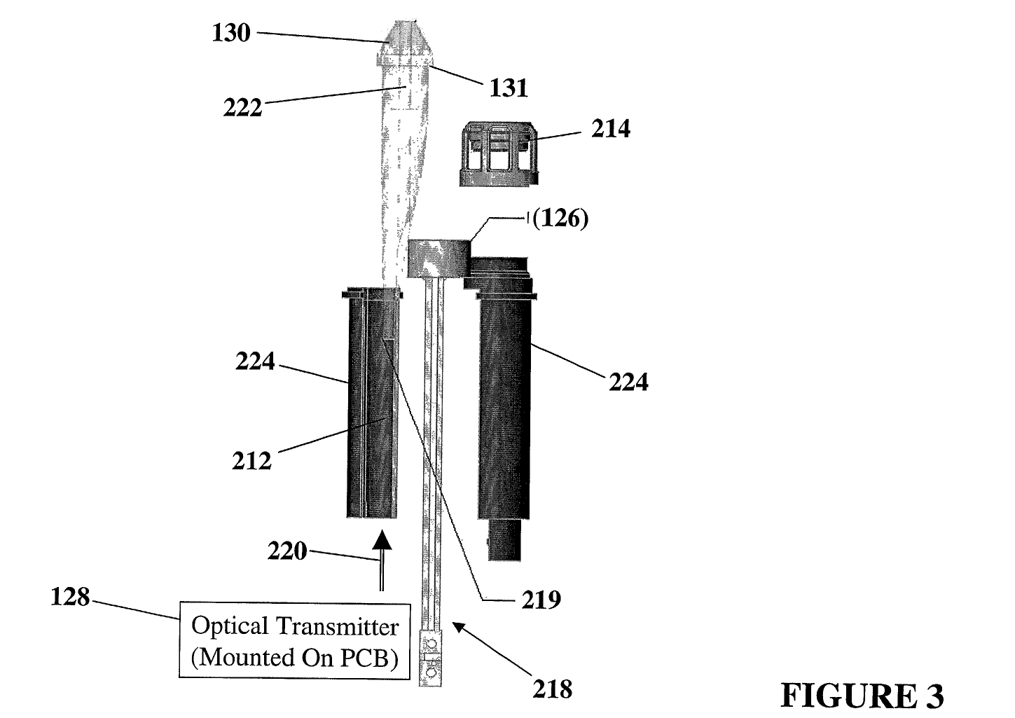

FIG. 3 is an exploded view of stylus 116. In its assembled configuration, stylus 116 comprises light pipe 222 positioned within protection grid 214 and within ultrasonic transducer 126 (which may be a piezo film ultrasonic transmitter). The light pipe 222 is optically coupled to optically conductive channel 212 to funnel optical energy between the light pipe 222 and the optical transmitter 128. Optical channel 212 is formed within stylus 116. Optical channel 212 may comprise any appropriate optically conductive channel, such as an optical waveguide, an optical fiber, or air. Optical channel 212 may be achromatic, in that the channel is optically transparent to all wavelengths of light. In another embodiment, optical channel 222 is transparent to infrared energy, and may not necessarily be achromatic. In an alternative embodiment, light pipe 222 is optically coupled directly to the optical transmitter 128. This direct coupling may comprise any of several mechanisms, such as light pipe 222 being positioned in physical contact with the optical transmitter 128, or light pipe 222 being fused, welded, or adhesively coupled to optical transmitter 128.

Light collecting and focusing tip 130 may comprise any optically conductive material, such as polycarbonate. In alternative embodiments, the optically conductive material may be achromatic, or limited to being optically conductive to infrared energy. Light pipe 222 may also comprise any optically conductive material, such as polycarbonate, and in alternative embodiments, the optically conductive material may be achromatic, or limited to being optically conductive to infrared energy.

Various embodiments of light pipe 222 and tip 130 are envisioned. In a first embodiment, light pipe 222 and tip 130 are integrally formed from a single piece of material, such as polycarbonate, for example. For example, tip 130 and light pipe 222 may be formed from a single mold of polycarbonate or other appropriate material. In another embodiment, light pipe 222 and tip 130 are separate pieces of material. Thus, light pipe 222 and tip 130 may be formed by separate molds of polycarbonate or other appropriate materials. Further, when the light pipe 222 and the tip 130 are formed as separate pieces, a portion of light pipe 222 may be inserted into the tip 130 as shown in FIGS. 2 and 3, or the light pipe 222 may not be inserted into tip 130 but rather may be coupled to the circular shaped base 131 of conical (or frustum) shaped tip 130. Light pipe 222 and tip 130 may be coupled by any appropriate means, such as welded, fused, adhesively coupled with an optically transparent adhesive, or positioned in close proximity to each other.

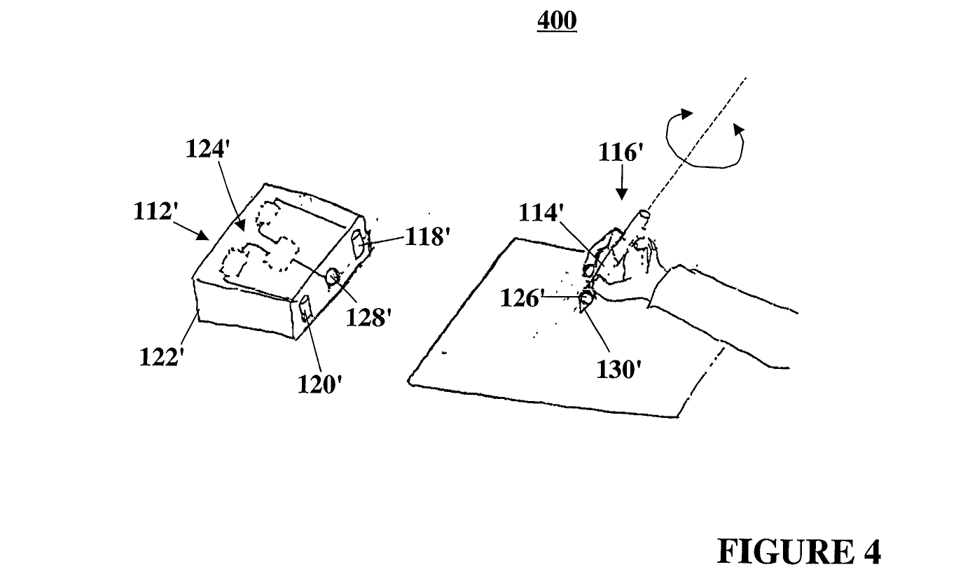

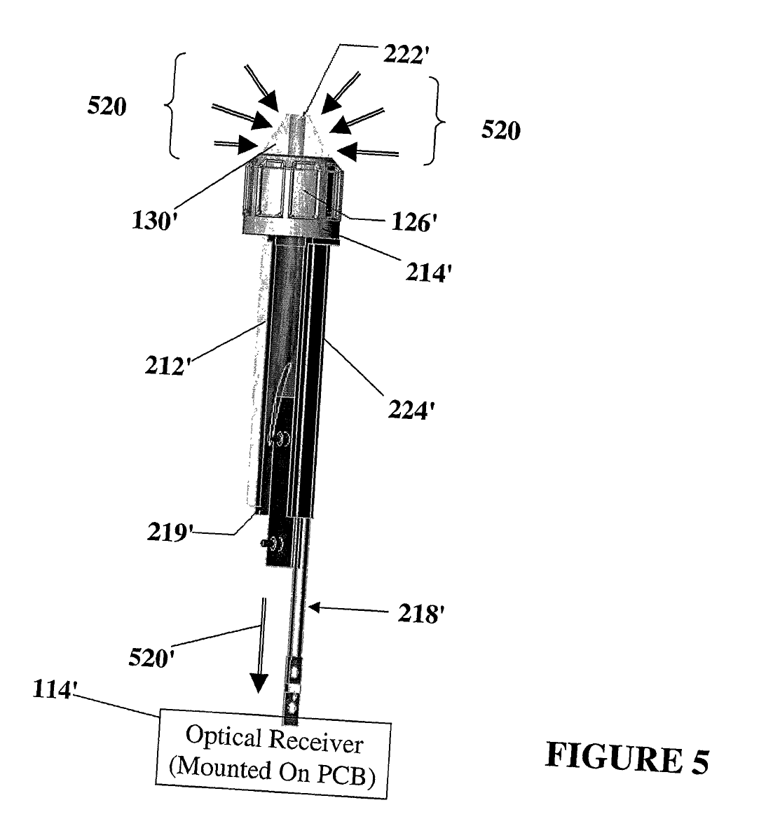

FIGS. 4 and 5 are illustrations of a system and stylus, respectively, , wherein the positions of the optical transmitter 128′ and optical receiver 114′ are interchanged. FIG. 4, is a perspective view of a digitizer system 400 wherein the fixed transceiving portion 112′ comprises at least one optical transmitter 128′ and the stylus 116′ comprises an optical receiver 114′. Digitizing system 400 functions in a similar manner to system 100, however optical signals are provided by optical transmitter 128′ positioned on fixed transceiving portion 112′, and the optical signals are received by the optical receiver 114′ positioned within stylus 116′.

FIG. 5 shows a portion of the stylus 116 of FIG. 4, wherein the stylus comprises an optical receiver 114′. Arrows 520 indicate the direction and propagation paths of the optical signals provided by the optical transmitter 128′ on fixed transceiving portion 112′. The optical signals (e.g., infrared signals, visible light) as provided by optical transmitter 128′, propagate through tip 130′ to light pipe 222′, through an optically conductive channel 212′ within the stylus 116′, to the optical receiver 114′. Location 219′ of the optically conductive channel 212′, is aligned with the optical receiver 114′ to provide optical coupling such that conductive channel 212′ is in optical communication with optical receiver 114′.

The optical signals can be received by tip 130′ from approximately all directions as shown by arrows 520. The omnidirectionally received optical signals are redirected by the tip 130′ to propagate to light pipe 222′ through optical channel 212′, to the optical receiver 114′ mounted on the printed circuit board.

In yet another embodiment of the invention, light pipe 222 may be optically coupled directly to the optical receiver 114. This direct coupling may comprise any of several mechanisms, such as light pipe 222 being positioned in physical contact with the optical receiver 114, or light pipe 222 being fused, welded, or adhesively coupled to optical receiver 114.

With only a single optical transmitter or single optical receiver mounted within the portable transceiving portion (e.g., stylus) of the exemplary systems 100 and 400, optical communication can be maintained between at least one optical transmitter and at least one optical receiver, regardless of the orientation of the stylus 116 about its axis. This allows a reduction in circuitry, weight and power consumption.

Many other variations are contemplated. For example, the number of ultrasonic transducers (e.g., 118, 120) on fixed transceiving portion 112 may be more or less than two. Also, the number of optical receivers 114 on fixed transceiving portion 112 (as in system 100), may be more than one, and the number of optical transmitters 128 on fixed transceiving portion 112 (as in system 400), may also be more than one.

Although the invention is described in terms of exemplary embodiments, it is not limited thereto. Rather, the appended claims should be construed broadly, to include other variants and embodiments of the invention, which may be made by those skilled in the art without departing from the scope and range of equivalents of the invention. For example, tip 130 may be formed in a shape other than a frustum or a cone, such as a semispheriod, a semiparaboloid, or a semiellipsoid.

What is claimed is:

1. A device comprising:
an optically conductive tip for redirecting an optical signal, wherein said tip is in direct line of sight of one of the group consisting of at least one optical transmitter and at least one optical receiver; and
an optical conductor optically coupled to said tip, wherein said optical conductor is in direct line of sight of the other one of said group consisting of said at least one optical transmitter and said at least one optical receiver,
wherein the optical signal is transmitted by the optical transmitter and redirected to the optical receiver by the tip.

2. A device in accordance with claim 1, wherein:
said tip comprises one of the group consisting of an achromatic material, an infrared transparent material, achromatic polycarbonate, and infrared transparent polycarbonate; and
said optical conductor comprises one of the group consisting of an achromatic material, an infrared transparent material, achromatic polycarbonate, and infrared transparent polycarbonate.

3. A device in accordance with claim 1, wherein said optical signal comprises at least one of the group consisting of an infrared signal and a visible light signal.

4. A device in accordance with claim 1, wherein said tip and said optical conductor are integrally formed from a single piece of material.

5. A device in accordance with claim 1, wherein said tip is conical or frustum shaped and said optical conductor is approximately cylindrical.

6. A device in accordance with claim 5, wherein a portion of said optical conductor is positioned within said tip.

7. A device in accordance with claim 5, wherein said optical conductor is coupled to a base of said conical tip.

8. The device of claim 1, wherein the tip redirects the optical signal in a plurality of radial directions distributed around a longitudinal axis of the device.

9. The device of claim 8, wherein the tip distributes light omnidirectionally.

10. The device of claim 1, wherein the device is a stylus, and the tip is at the end of the stylus

11. An apparatus comprising:
a housing having a longitudinal axis;
a first optical device positioned within said housing;
an optically conductive tip mounted to said housing, an axis of said tip being coaxial with said axis of said housing, wherein said tip is in direct line of sight of a second optical device; and
an optical conductor that optically couples the first optical device to said tip,
wherein the first and second optical devices are optically coupled to each other by way of the tip and the optical conductor, regardless of an orientation of said housing about its longitudinal axis.

12. An apparatus in accordance with claim 11, wherein:
said first optical device comprises one of the group consisting of a single optical receiver and a single optical transmitter;
said second optical device comprises at least one optical transmitter if said first optical device comprises a single optical receiver; and
said second optical device comprises at least one optical receiver if said first optical device comprises a single optical transmitter.

13. An apparatus in accordance with claim 11, further comprising an optically conductive channel formed within said housing, wherein said channel is positioned between said optical conductor and said first optical device.

14. An apparatus in accordance claim 11, further comprising an ultrasonic transducer.

15. An apparatus in accordance claim 11, wherein:
said second optical device comprises at least one of the group consisting of a light emitting diode and a laser diode, if said first optical device comprises one of the group consisting of a photodiode and a photodetector; and
said second optical device comprises at least one of the group consisting of a photodiode and a photodetector, if said first optical device comprises one of the group consisting of a light emitting diode and a laser diode.

16. An apparatus in accordance claim 11, wherein said apparatus is stylus shaped.

17. An apparatus in accordance claim 11, wherein said tip is conical or frustum shaped.

18. A system for determining the position of a stylus, said system comprising:
a fixed transceiving portion for transceiving ultrasonic and optical signals, said fixed transceiving portion comprising:
at least one ultrasonic transducer;
one of the group consisting of at least one optical receiver and at least one optical transmitter; and
said stylus comprising:
an ultrasonic transducer;
one of the group consisting of a single optical transmitter and a single optical receiver; wherein a position of said stylus is determined in accordance with said optical signals and propagation times of said ultrasonic signals.

19. A system in accordance with claim 18, wherein:
said fixed transceiving portion comprises:
a plurality of ultrasonic transducers; and
at least one optical transmitter; and
said stylus comprises:
a single ultrasonic transducer; and
a single optical receiver.

20. A system in accordance with claim 18, wherein:
said fixed transceiving portion comprises:
a plurality of ultrasonic transducers; and
at least one optical receiver; and
said stylus comprises:
a single ultrasonic transducer; and
a single optical transmitter.

21. A system in accordance with claim 18, said stylus further comprising:
an optically conductive tip mounted to said stylus, said stylus having an axis, wherein said tip is in direct line of sight of one of said at least one optical transmitter and said at least one optical receiver on said fixed transceiving portion, such that optical coupling between said tip and said at least one optical transmitter and at least one optical receiver on said fixed transceiving portion is maintained regardless of an orientation of said stylus about its axis;
an optical conductor optically coupled to said tip, wherein:
at least a portion of said optical conductor is positioned within said stylus;
said optical conductor is in direct line of sight of one of said single optical transmitter and said single optical receiver positioned within said stylus; and
said tip is optically coupled to the other of said at least one optical transmitter and said at least one optical receiver on said fixed transceiving portion.
